(19) United States
(12) Patent Application Publication
(10) Pub. No.: US 2026/0020589 A1
(43) Pub. Date: Jan. 22, 2026

(54) PULSATING TIME VARYING FREQUENCY ELECTROMAGNETIC WAVE COMPONENTS FOR TASTE ENHANCEMENT OF FOODS AND BEVERAGES

(71) Applicant: Ecospec Noveltech Pte. Ltd., Singapore (SG)

(72) Inventors: Marius Abella ASERON, Quezon City, Metro Manila (PH); Xavier Alexen Roxas ASERON, Quezon City, Metro Manila (PH); Jan Adrian Roxas ASERON, Quezon City, Metro Manila (PH); Hwee Hong CHEW, Singapore (SG)

(73) Assignee: Ecospec Noveltech Pte. Ltd., Singapore (SG)

(21) Appl. No.: 17/923,952

(22) PCT Filed: Sep. 2, 2020
(86) PCT No.: PCT/PH2020/050009

§ 371 Date: Nov. 8, 2022

(30) Foreign Application Priority Data
May 8, 2020 (PH) 1-2020-050 127

(51) Int. Cl. A23L 5/30

(52) U.S. Cl. CPC A23L 5/30

(57) ABSTRACT

A pulsating time varying frequency electromagnetic wave components for enhancement of taste of foods and beverages comprising a power supply unit, a printed circuit board connected to said power supply unit and conductor probe units connected to said printed circuit board wherein said conductor probe units are taken from a group consisting of straight rods, plates, meshes and coils; said power supply unit is taken from a group consisting of pulsed switching power supply, wet battery, dry battery and transformer rectifier, and said printed circuit board is adapted to produce low, medium and high frequency range time varying wave.

### FIELD OF THE INVENTION

The present invention is a food and beverage enhancement method and system which more specifically relates to the application of pulsating time varying frequency electromagnetic (EM) wave field components for enhancement of antioxidizing property and taste of foods and beverages. The system comprises at least one power supply unit, a printed circuit board (PCB) for generation of pulsating time varying electromagnetic wave, and a foods and beverages treatment unit. The treatment unit provides a time-varying EM field for the treatment of foods and beverages and comprises a conductor probe unit and/or coil units. The conductor probe unit provides a high capacitive and electric EM field and an ionic/electron wave current in electrolytes such as drinks. The coil units of various wiring configurations can be programmed to generate electric and magnetic EM fields of different strengths. Different time-varying frequency ranges of the EM field can be programmed by coupling to different PCBs. These different PCBs are programmed to generate varying EM wave frequencies (i.e., low, medium, high).

### BACKGROUND OF THE INVENTION

Good taste or flavor, nutritious, and healthy (including antioxidizing content (antioxidants)) are desirable qualities of foods and beverages as required by consumers, the Foods and Beverages (F&B) industry, F&B retail outlets, food stalls, restaurants and homes. Conventionally, food and beverages are made more palatable by the addition of salt, sugar, or other additives to either cooked or uncooked foods. Very often, due to the intensity of the original flavor of the ingredients, or in order to suppress the undesirable taste, more sugar, salts, artificial flavors or additives are added. Such a method of enhancement of taste and flavor is unhealthy and causes long term health issues. For example, bakeries and beverage makers, though fully aware of the health hazard of too much sugar added to food or drinks, cannot ignore the fact that without adding in more sugar or artificial flavor especially in cold drinks, the taste and fragrance of the drinks are not palatable to the consumers and consequently affect the sales of their products. To resolve the issue, some may resort to using artificial flavor, sugar substitutes to enhance sweet taste and aroma but this creates other health issues. Similarly, other additives such as (MSG) monosodium glutamate, artificial chemical flavors, etc. are also used in the industry for enhancing the taste of foods and beverages. There are also approaches such as using more sugar to suppress bitter taste, which makes the foods and beverages unhealthy. All these create long term public health issues such as diabetics, high blood pressure etc. The F&B makers are fully aware of these health issues but no known better alternative solution for taste enhancement is available.

Yet another health issue nowadays is that of free radical effect to the human body where there is an increased awareness that taking in antioxidant-containing food and drinks will help minimize the negative oxidative effect of free radicals to the human body. Unfortunately, many drinks and food available in the market are oxidizing, although they do have some antioxidants content, and these include black tea, wine, and even green tea and coconut drinks. To make such drinks antioxidizing, F&B makers may resort to the addition of chemicals, such as sodium bicarbonates or sodium hydroxide. Sodium as introduced in the process also introduces undesirable tastes altering the resulting food taste. Sodium is also known to worsen high blood pressure generating another health issue.

United States Patent Application Number 2018/0199760 A1 of Raison Investment, Incorporated teaches of a food and beverage treatment using a container having a captive rotatable magnet to induce spinning of a separate unattached stirring implement placed in the container. The captive rotatable magnet may be part of an active mixer attached to the container. It may also be passively housed in a chamber in the bottom of the container to be spun under the influence of an external mixer to transmit by coupling the spinning to the separate spinning implement. The stirring implement is magnetically retained within the container during the pouring of a mixed substance. However, the magnet or stirring implement may only affect the consistency of the food and beverage provided within the container and not the taste or flavor of the same.

Another prior art is disclosed in U.S. Pat. No. 9,873,097 B1 issued to Boris Dushine, wherein a system and method for automatically aerating drinking products, particularly wine, suitable home, business and/or industrial use is described. The system of the said invention is specifically designed for aerating wine for human consumption and includes a multipurpose stirring, storing and serving vessel having a captive magnetic stirring impeller coupled thereto and a programmable magnetic stir plate adapted for use therewith. However, like the previous prior art, Dushine's patent do not affect the taste or flavor of foods or beverages and, in fact, make the wine more oxidizing.

The above prior arts are only for liquid and have no feature for treating solid foods or changing the taste of foods. They cannot enhance the beneficial antioxidizing property of foods and beverages or convert oxidizing drinks to antioxidizing. Although magnetic stirrer is used in the prior art, the purpose of the magnetic stirrer is to provide the mechanical rotation stirring movement instead of using it to alter the biological or chemical structure of the foods and beverages. None of these prior arts can solve the antioxidizing and taste enhancement issues of F&B.

In view of the negative health impact of the current practices by F&B industries of using more additives, sugars, salts, MSG or other chemicals to enhance the taste or improve the antioxidizing property of foods and beverages, there is a necessity to find a solution without using, or at least minimizes using chemicals, additives, or artificial flavor. Object of the Invention:

It is therefore a main object of the present invention to provide for a system and method that employs pulsating time varying frequency electromagnetic wave components for the enhancement of the antioxidizing property and taste of foods and beverages, which solves the problem of the prior arts without using chemicals, sugar, salt or artificial additives, etc.

Another object of the preset invention is to provide a treatment system using pulsating time varying frequency electromagnetic waves coupling to conductive probes and/or inductor coils to produce different strengths of electric, magnetic component fields and ionic currents for antioxidizing and enhancing the taste of foods and beverages. Said system consists of:
1) a power supply unit;
2) a pulsating time varying frequency electromagnetic (EM) wave generating printed circuit board (PCB); and
3) a treatment unit which can be either one or combination of conductive probes, inductor coils of different coiling configurations.

At least one power supply unit is used in the system. The power supply unit is used to supply low voltage Direct Current (DC) to the printed circuit board to generate pulsating time varying electromagnetic waves. The power supply unit can be the conventional winding type transformer rectifier or an electronic pulse switching transformer rectifier. The transformer rectifier steps down the 110V, 230V or 440V alternative current (AC) to a low voltage such as below 60 volt and the AC current is rectified into DC current. DC generator will produce the DC current directly. Wet or dry battery can also be used as a power supply unit. However, the dry battery can be useful for portable treatment units. In general, the maximum DC voltage from the power supply output to the PCB input should not exceed the voltage rating of the PCB components, and it must be within the safety limit requirement. Typically, the DC voltage from the power supply unit to the PCB is less than 60 volts.

Another object of the present invention is to provide a system and method for the antioxidation and enhancement of taste of foods through the use of a PCB that generates suitable and that, through the PCB that generates suitable pulsating time varying frequency electromagnetic wave components and inputs these wave components to the system to create the EM field and/or ionic current.

The PCB may be analog or digital in design. Primarily, the PCB must be programmed to suit the different types of EM field loads in the enhancement treatment unit. The EM field load may be high or low in electric field and may be low or high in magnetic field. In the case of the conductive probe treatment in the treatment unit, the PCB shall be programmed to take high capacitive and/or resistive load to produce high electric field and ionic current in the electrolyte.

The EM wave produced by the PCB can be square, triangular, sine or other waveform and the frequency range may be between 1 Hz to 1 MHz. The frequency range may preferably be between 100 Hz to 500 KHz. The frequency range may be subdivided into low frequency, mid and high frequency range.

The time varying sweeping frequency for the time varying frequency wave is in the range of 1 to 1000 Hz and preferably between 10 Hz to 100 Hz.

Another object of the present invention is to provide for a pulsating time varying frequency electromagnetic wave components for enhancement of taste of foods and beverages wherein said printed circuit board is adapted to produce low frequency range time varying wave.

Another object of the present invention is to provide for a pulsating time varying frequency electromagnetic wave components for enhancement of taste of foods and beverages wherein said printed circuit board as adapted to produce medium frequency range time varying wave.

Another object of the present invention is to provide for a pulsating time varying frequency electromagnetic wave components for enhancement of taste of foods and beverages wherein said printed circuit board as adapted to produce high frequency range time varying wave.

Another object of the present invention is to provide for a pulsating time varying frequency electromagnetic wave components for enhancement of taste of foods and beverages wherein said conductor probe units are adapted to create in its vicinity time varying electromagnetic field.

Another object of the present invention is to provide for a pulsating time varying frequency electromagnetic wave components for enhancement of taste of foods and beverages wherein said conductor probe units are adapted to produce high electric field and low magnetic field.

Another object of the present invention is to provide for a pulsating time varying frequency electromagnetic wave components for enhancement of taste of foods and beverages wherein said conductor probe units are adapted to produce pulsed ionic/electron wave in an electrolyte.

Another object of the present invention is to provide for a pulsating time varying frequency electromagnetic wave components for enhancement of taste of foods and beverages wherein said power supply unit is adapted to provide direct current power to the printed circuit board.

Another object of the present invention is to provide for a pulsating time varying frequency electromagnetic wave components for enhancement of taste of foods and beverages wherein said printed circuit board is adapted to convert the direct current power into various frequency ranges of time varying wave.

Another object of the present invention is to provide for a method of enhancing taste of foods and beverages using pulsating time varying frequency electromagnetic wave components comprising the steps of:
supplying power to a printed circuit board connected to a power supply unit;
connecting conductor probe units to the printed circuit board, and
subjecting foods and beverages to the conductor probe units wherein said conductor probe units are taken from a group consisting of straight rods, plates, meshes and coils.

Another object of the present invention is to provide for a method of enhancing taste of foods and beverages using pulsating time varying frequency electromagnetic wave components wherein said power supply unit is taken from a group consisting of pulsed switching power supply, wet battery, dry battery and transformer rectifier.

Another object of the present invention is to provide for a method of enhancing taste of foods and beverages using pulsating time varying frequency electromagnetic wave components wherein said printed circuit board is adapted to produce low frequency range time varying wave.

Another object of the present invention is to provide for a method of enhancing taste of foods and beverages using pulsating time varying frequency electromagnetic wave components wherein said printed circuit board as adapted to produce medium frequency range time varying wave.

Another object of the present invention is to provide for a method of enhancing taste of foods and beverages using pulsating time varying frequency electromagnetic wave components wherein said printed circuit board is adapted to produce high frequency range time varying wave.

Another object of the present invention is to provide for a method of enhancing taste of foods and beverages using pulsating time varying frequency electromagnetic wave components wherein said conductor probe units are adapted to create in its vicinity time varying electromagnetic field.

Another object of the present invention is to provide for a method of enhancing taste of foods and beverages using pulsating time varying frequency electromagnetic wave components wherein said conductor probe units are adapted to produce high electric field and low magnetic field.

Another object of the present invention is to provide for a method of enhancing taste of foods and beverages using pulsating time varying frequency electromagnetic wave components wherein said conductor probe units are adapted to produce pulsed ionic/electron wave in an electrolyte.

Another object of the present invention is to provide for a method of enhancing taste of foods and beverages using pulsating time varying frequency electromagnetic wave components wherein said power supply unit is adapted to provide direct current power to the printed circuit board.

Another object of the present invention is to provide for a method of enhancing taste of foods and beverages using pulsating time varying frequency electromagnetic wave components wherein said printed circuit board is adapted to convert the direct current power into various frequency ranges of time varying wave.

Yet, another object of the present invention is to provide for a pulsating time varying frequency electromagnetic wave components for enhancement of taste of foods and beverages to resolve the above taste issues of the prior arts by better extraction/exploration and enrich the original tastes content of raw materials.

Yet, another object of the present invention is to provide for a pulsating time varying frequency electromagnetic wave components for enhancement of taste of foods and beverages that improves the taste, aroma and flavor reactions with water contents in food and drinks; and saliva enhancing the taste of starch content, sugar, salt and other chemical taste enhancers or additives.

Yet, another object of the present invention is to provide for a pulsating time varying frequency electromagnetic wave components for enhancement of taste of foods and beverages that enables changing the beverages and liquid foods oxidation and reduction potential either to more reductive or oxidative potential using the capacity and resistive electromagnetic field components treatment. The present invention can also convert drinks from oxidizing to anti-oxidizing making.

Yet, another object of the present invention is to provide for a pulsating time varying frequency electromagnetic wave components for enhancement of taste of foods and beverages that uses only physical time varying frequency pulsed magnetic, electric, capacity field method to better extract the content and essence in the ingredients including meat and vegetables, yet without further addition of sugar, salts, flavor additives or chemicals.

Still, another object of the present invention is to provide for a pulsating time varying frequency electromagnetic wave components for enhancement of taste of foods and beverages that better activates and enhances the taste, aroma, texture of food and beverages in the production and human taste sensory process.

Still, another object of the present invention is to provide for a pulsating time varying frequency electromagnetic wave components for enhancement of taste of foods and beverages wherein oxidative and reductive potential (ORP) of drinks and liquid food can be selectively changed to produce the desirable effect.

Still, another object of the present invention is to provide for a pulsating time varying frequency electromagnetic wave components for enhancement of taste of foods and beverages that also maximizes the extraction of full contents and nutrient from raw ingredients and fully explore the original taste of the raw ingredients hence requires lesser amount of MSG, salts, sugar, artificial flavor addition, yet the fully spectrum of foods and beverages tastes still can be realized. The good flavor of food in general refers to three key factors; the taste, aroma/fragrance and texture. Tastes of foods and beverages consist of five basic tastes namely, sweetness, saltiness, sourness, bitterness and umami. Most tastes are combination of two or more of these basic tastes. These basic tastes each have its own characterized chemical composition/component. These chemical constituents when in contact with taste buds of the human tongue, they will either attached onto the taste bud cells or migrate through the taste bud ion channels. Taste nerve senses these chemical taste signals and sends through the sensory system to brain hence detected the taste. The taste transmittal process from the food reactions through taste bud membrane via the human sensory system to brain is determined by the chemical and ionic reactions energy and rates/potential difference/electrons transfer process. It also depends on the concentration of the various chemical components in the food and beverages which mixes the senses and intensity of taste creating different final tastes.

Still, another object of the present invention is to provide for a pulsating time varying frequency electromagnetic wave components for enhancement of taste of foods and beverages that provides a fast and efficient way to better extract the food and drinks essences/flavor without using excessive heat/high temperature or extraction chemical yet preserving the desirable nutritious/beneficial content in food and drinks.

Still, another object of the present invention is to provide for a pulsating time varying frequency electromagnetic wave components for enhancement of taste of foods and beverages that uses the time varying pulsed wave with the correct combination of various wave components/parameters and strength to facilitate better extraction of contents from plant and meats and other raw materials.

Still, another object of the present invention is to provide for a pulsating time varying frequency electromagnetic wave components for enhancement of taste of foods and beverages wherein the time varying pulsed wave treatment methods increases the cell wall permeability of meats and plants raw ingredients hence facilitate easier extraction of content from cells. It can be direct or indirect contact extraction process. The time varying wave treatment can be used in conjunction or complement the existing heating process hence reducing the high temperature negative effects and preserving the nutrients in food and beverages.

Still, another object of the present invention is to provide for a pulsating time varying frequency electromagnetic wave components for enhancement of taste of foods and beverages wherein each of the five [5] different basic tastes can be individually controlled by using combination of different ranges of time varying pulses/frequency wave with different strength of electric/magnetic field components or ionic/electron wave current. The treatment can selectively use either one or combination of all five [5] different tastes treatment.

Still, another object of the present invention is to provide for a pulsating time varying frequency electromagnetic wave components for enhancement of taste of foods and beverages that provides various adjustments to facilitate easier choice of taste or flavor treatment settings by the consumers to obtain their most preferred taste setting for different type of food and beverages.

### BRIEF DESCRIPTION OF THE DRAWINGS

The present invention for a pulsating time varying frequency electromagnetic wave components for enhancement of taste of foods and beverages will be further described with reference to the accompanying drawings, wherein like-reference numerals refer to like parts in the several views, and wherein

FIG. 1 is a plan view of the present invention for a pulsating time varying frequency electromagnetic wave components for enhancement of taste of foods and beverages; and

FIG. 2 is another plan view showing details of said pulsating time varying frequency electromagnetic wave components for enhancement of taste of foods and beverages.

FIG. 3 shows wire coils.

FIG. 4 shows a wire coil.

FIG. 5 shows an acid or alkaline generator.

FIG. 6 shows water O—H bond (FITR) absorbance peak changes.

FIG. 7 shows stretching or compression of hydrogen bonds.

FIG. 8 shows hydrogen bonds facilitate correlated electron movement between molecules.

FIG. 9 is a graph of surface tension against time.

### DETAILED DESCRIPTION

Referring now to the different views of the drawings, there is shown the present invention for a pulsating time varying frequency electromagnetic wave components for enhancement of taste of foods and beverages being designated with reference numeral 10. Said pulsating time varying frequency electromagnetic wave components for enhancement of taste of foods and beverages 10 comprises a power supply unit 11, a printed circuit board 12 connected to said power supply unit 11 and conductor probe units 13 connected to said printed circuit board 12 wherein said conductor probe units 13 are taken from a group consisting of straight rods, plates, meshes or other shapes, and coils.

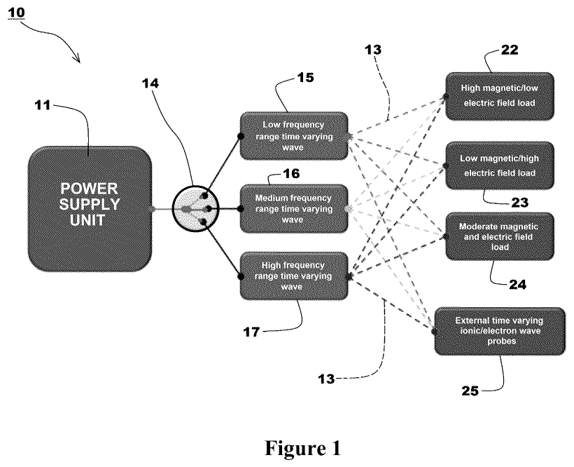

As shown in FIG. 1, a control device 14 is provided on said printed circuit board 12 wherein said control device 14 allows the printed circuit board 12 to produce low frequency range time varying wave 15, medium frequency range time varying wave 16 and high frequency range time varying wave 17. The control device 14 allow a user to select and pre-program time varying frequency ranges and sweeping frequency that will be suited to different types of food and beverages. Said control device 14 can also allow the pulsating time varying frequency electromagnetic wave components for enhancement of taste of foods and beverages 10 to produce high magnetic/low electric field load 22, low magnetic/high electric field load 23, moderate magnetic and electric field load 24 and a separate external time varying ionic/electron wave 25.

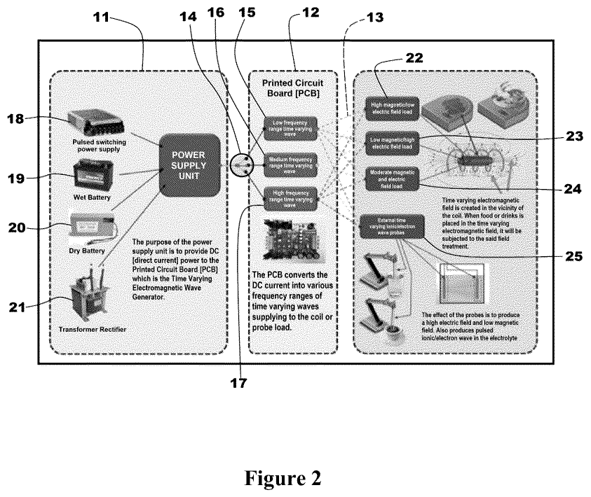

As shown in FIG. 2 of the drawings, the pulsating time varying frequency electromagnetic wave components for enhancement of taste of foods and beverages 10 is provided with a power supply unit taken from a group consisting of pulsed switching power supply 18, wet battery 19, dry battery 20 and transformer rectifier 21. Input voltage can be 110/220/440V 50/60 Hz, single or three phases. Output voltage to printed circuit board 12 and to load shall not exceed 60V to comply with safety standard although higher voltage can be used if it can comply with safety requirement and electronic component voltage specification limits. The power supply unit 11 is essentially a DC power supply to the printed circuit board 12. The power supply unit 11 can be any DC battery source which provided the most basic +/− polarities. The voltage of the power supply unit 11 may be varied according to the printed circuit board 12 card voltage requirements. In general, if high magnetic field/low electric field is needed, lower voltage is used. For high electric field/low magnetic field, or ionic/electron wave current is needed, then higher voltage power supply unit will be used. In general, maximum voltage of the power supply unit 11 is limited by two factors. Safety consideration—Most safety certifications only allow maximum voltage of no more than 60V at the output and printed circuit board 12 component limitations—many components in the printed circuit board 12 especially the switching component MOSFET can only withstand up to a maximum 60V.

Power supply unit 11 may also use pulsed switching power supply 18 that converts 50 Hz/60 Hz AC sine wave power supply 110/220V into a high frequency DC pulsed wave. Due to high frequency, ripple is so small that it acts like a pure DC power supply unit. Different AC input voltage, Hz, or single phase or three phases to power supply unit 11 may be used depending on the design of the power supply unit 11.

Conventional transformer rectifier 21 using coil winding transformer and with half or full wave bridge rectifier may be used as power supply unit 11 too.

Direct current wet battery 19 or direct current dry battery 20 including various types of dry battery such as Lithium, alkaline etc. It can be either in single or multiple units, connected in series or parallel, can also be used as power supply unit 11 for the pulsating time varying frequency electromagnetic wave components for enhancement of taste of foods and beverages 10. The power supply unit 11 can also be chargeable or non-rechargeable.

Direct current power from the power supply unit 11 will be converted into time varying frequency wave by the printed circuit board 12. In the printed circuit board 12, DC power is programmed in a chip (not shown) and through switching by MOSFET converting into time varying pulsed wave. There are many possible program and component designs which can be used to produce the following output specifications.

Time varying electric or magnetic field with different frequency range, sweeping frequency, duty cycle etc. have different effect in enhancing different taste, and this effect can only be produced by using different types of load to produce the treatment field on the foods and beverages.

In the conventional electromagnetic wave coil load winding, it produces both the electric and magnetic field perpendicular to each other. However, for taste enhancement treatment, due to electric and magnetic field each has different effect on taste/extraction/aroma etc., it is therefore necessary to have better control on the production or strength of individual electric and magnetic field components. Although 100% pure electric or magnetic field is impractical to produced due to the co-dependent and mutual inducing properties, unless permanent magnet may be used to cancel the produced time varying magnetic field but not 100% perfect. In this invention, innovative winding methods enable production of different strength of electric or magnetic field to suit different taste enhancement requirement, for example very high strength electric with very low magnetic field.

In the conventional electromagnetic wave coil winding, typically one single conductor is used to coil on either hollow or ferrite core. The winding may be multi or single layer, opposite direction or single direction, but in all cases, it is unable to control the relative strength of electric and magnetic field.

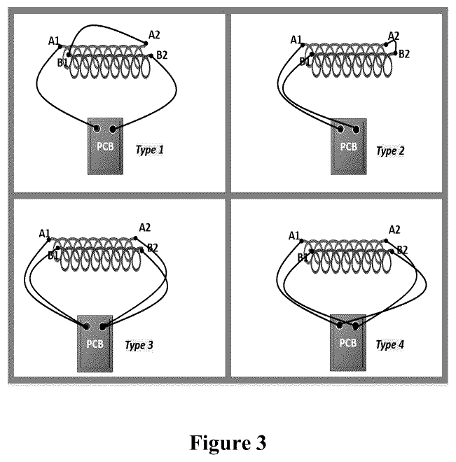

In the present invention for a pulsating time varying frequency electromagnetic wave components for enhancement of taste of foods and beverages 10, two conductor probe units 13 in a form of wire coils are used and coiled in parallel either on hollow, ferrite or other materials. By different wire coils end connections; it produces more than four basic different kinds of field effects as shown in the following. Different electric or magnetic field strength as produced by this method will facilitate treatment for different types of tastes. Examples of wire coils are shown in FIG. 3.

The following result is obtained using the same number of turns for the dual concentric, same diameter conductor probe units 13 to produce the various high and low electric/magnetic field effects using the coils connections and configuration shown in FIG. 3.

| | | | | | | | Magnetic | Electric |
|---|---|---|---|---|---|---|---|---|
| | | L | | C | | R | field | field |
| Coil type | | Inductance | | Capacitance | | Resistance | Strength | strength |
| Coils | Type 1 | 102.8 | uH | 2.46 | uF | 0.235 ohm | Very high | Very low |
| connections | Type 2 | 1.43 | uH | 176.3 | uF | 0.085 ohm | Very Low | Very High |
| & | Type 3 | 25.39 | uH | 9.984 | uF | 0.089 ohm | Moderate | Moderate |

| | | | | | | | |
|---|---|---|---|---|---|---|---|
| configuration | Type 4 | 0.56 | uH | Over - | 0.04 ohm | Extreme | Extreme |
| | | | | range | | Low | high |

In FIG. 3 only cylindrical shape probe units 13 in coil form are shown, other shape of coil (such as round, toroid, square or other geometrical shape, relative position of coils may be used too. Depending on applications, more than two coils can be used to connect to the same printed circuit board 12.

In each coil, the number of turns, coil diameter and length of coil may be also be altered or using different coil turn tapping points such as the following figure to further amplify/reducing the electric or magnetic field effect but the basic dual coil wiring principle is the same.

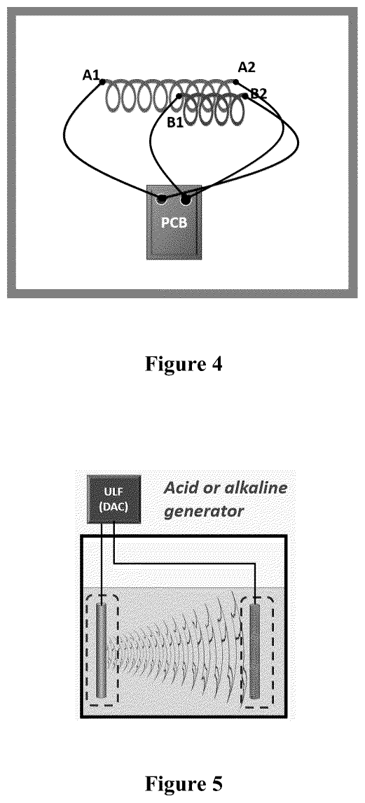

In addition to the above possible coil wire connections shown in FIGS. 3 and 4, the coils may be coiled as hollow core, or on ferrite core, or other materials that could improve the magnetic or electric field.

| | | | | |
|---|---|---|---|---|
| Alloy | FeNiMo | FeNi | FeSiAl | FeSi |
| Composition | | | | |

The conductor probe units 13 may be copper, aluminum or other metals, and it can be insulated and shielded or simple enamel/Teflon/PVC/PE etc. insulation.

In general, external time varying wave ionic/electron wave current probes instead of coils is used for acceleration of treatment but the conductor probe units 13 must be in contact with the food or beverages. The moisture content, water or electrolyte present in the food or beverages will act as a conductive media/path for the ionic/electron wave current to pass through the food and beverages. The wave current has better penetration property compared with just the magnetic or electric field only. It gives better extraction efficacy and faster taste and energy enhancement treatment.

The external ionic/electron wave current probe is different from coil as conductor probe units 13 does not produce or only very weak magnetic field and it has ionic/electron wave current in water which cannot be produced by coil. The ionic/electron wave current probe is very effective in reducing the astringency of wine or alcoholic drinks, tea, coffee etc., and in producing the antioxidizing effect.

The external time varying ionic/electron wave current probe can also be used to produce either acidic or alkaline water by using a polypropylene PP cloth, membrane or other semi permeable separators to separate the two probes. The conductor probe units 13 shall be food grade non consumable material such as platinized titanium or niobium etc. if they are in direct contact with foods or beverages.

With the configuration shown in FIG. 5 and based on taste enhancement treatment concept, it will form 12 basic different possible adjustment paths to get wide ranges of possible combination of taste enhancement. However, taste for various types of food and beverages is unlimited and they are complex combination of different basic tastes. When multiple basic tastes are combined, the treatment selection of the above 12 basic selections will need to be re-adjusted to get the preferred tastes.

The following explains why time varying wave able to individually enhance the desirable taste and/or remove the undesirable taste.

The five basic tastes as described herein refers to the pickup of different taste chemicals in food and beverages by the human tongue taste bud cells. Taste bud receptor cell senses these chemicals and transmitting it via charge signal through human sensory system to the brain to identify these five basic tastes. When more than one basic tastes are mixed and pick up together, taste buds and sensory system will identify it as a new combined tastes although it is still consisting of the same basic taste/tastes.

For our brain to identify the tastes, there are three major factors strongly affect the taste identification and reception.

First factor—Basic taste chemical types and quantity. It is the taste chemical types and concentration in the foods and beverages. For example; starch/sugar/glucose will contribute to sweetness. If more starch/sugar or higher sugar content chemicals is present, will be pickup as sweeter taste to the brain after reacting with saliva. If the sweet taste chemical type/composition is changed or concentration is altered, it will give another kind of taste or different taste intensity.

The following is the typical chemical contents contributing to the five basic tastes.

Sweet—it can be sugar (glucose), sucrose, fructose etc. the typical chemical content of sugar, sucrose, fructose etc. are given in the following,

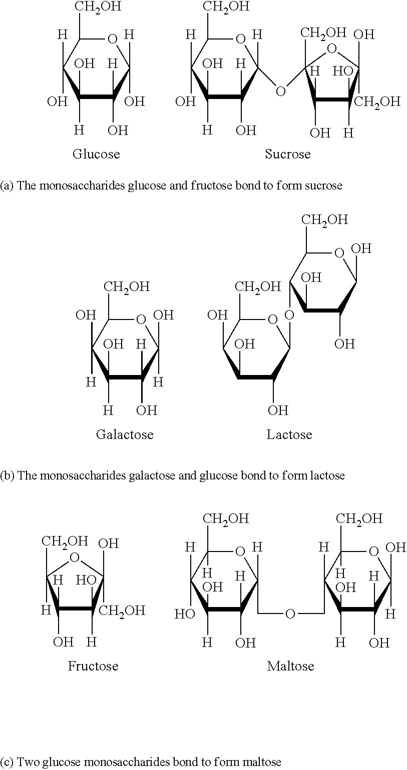

Sour—which is acid H⁺.Different type of sourness typically come from the organic acids content in foods and beverages such as citric acid, vinegar etc. However, all these different sourness content produce the same H⁺ ions which contribute to the sour taste.
Salty—Contributed mainly by Na⁺. Others such as K⁺ which contribute to weaker saltiness and it is much weaker compared with Na⁺.
Bitter—Contributed mainly by a much larger group of chemicals contents similar to drug/toxin like molecules such as Polyphenols and alkaliods etc. Typically benzene ring structures is present in this group of chemicals contents.

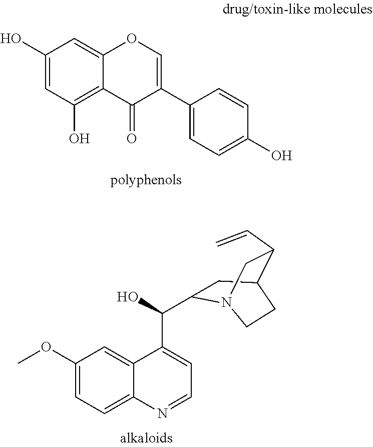 [SMILES: O=c1c(-c2ccc(O)cc2)coc2cc(O)cc(O)c12 ; C=CC1CN2CCC1CC2[C@H](O)c1ccnc2ccc(OC)cc12]

Umami or Savory—contribute mainly by the glutamate.

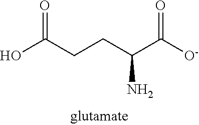

Second factor—Chemical reactivity energy/potential difference across taste bud membrane. Human tongue sensory system picks up the basic taste through the taste bud cells. Different taste chemicals either attached onto the taste cell receptors or migrate through the taste bud/cell ions channel. The reactivity of the chemicals attaching on the bud cell or migration through the cell ion channel will determine the taste sense transmittal to the brain. The attachment or migration through ion channels of taste chemicals involves available chemical reactivity energy (free energy) at the reaction site. If the chemicals types and quantity remain the same, the free energy available at taste bud reaction site will determine the taste difference. If the free energy causes the change in hydration of taste chemicals or reactions between taste chemicals, the final tastes will be different too.

Third—Water/Saliva. Our taste buds are chemoreceptors which require a liquid medium for the taste to bind onto the receptor molecules. Without water/saliva, receptor will not be able to pick up the taste. Technically, water or saliva must be present in tasting. The only difference is saliva contains amylase, an enzyme that acts on sugars and other carbohydrates, and water does not contain these enzyme. The rate at which Amylase breaks down into sugar will determine the sweet tastes differences and this rate is also determined by the quantity of saliva, the free energy available to the breakdown reaction. But the function of water acting as binding and free energy carrying media in tasting is the same.

Water also has another unique property which is responsive to time varying frequency pulsed wave treatment. Vibration energy of water O-H bonds and hydrogen bonds increases when water is subjecting to correct time varying frequency pulsed wave treatment. Other charged ions, molecules in water are also affected by both the correct electric and magnetic fields of the time varying frequency pulsed wave. Once the vibration energy (entropy energy) of water is excited, it provides the entropy free energy to the taste bud reaction site hence promote better general overall taste pick up.

Based on the above explanation, it is obvious that the conventional approach in enhancing the foods and beverage tastes is based on altering the first factor which is changing the chemical type/quantity/content of the foods and beverages. But by this approach it often causes other undesirable side health issues as mentioned above.

By conventional approach, it is difficult to improve second and third factor as addition of chemicals changes only first chemical content but unable to alter the foods and beverages energies in second and third factors.

However with correct time varying frequency pulsed wave treatment to the foods and beverages, the hydrogen bonds, polar bonds, ionic bonds, benzene rings, O—H bonds in water and food/beverages may be selectively or non-selectively energized or broken by different time varying wave components including frequency range, strength of electric or magnetic components, voltage sweeping frequency wave etc.

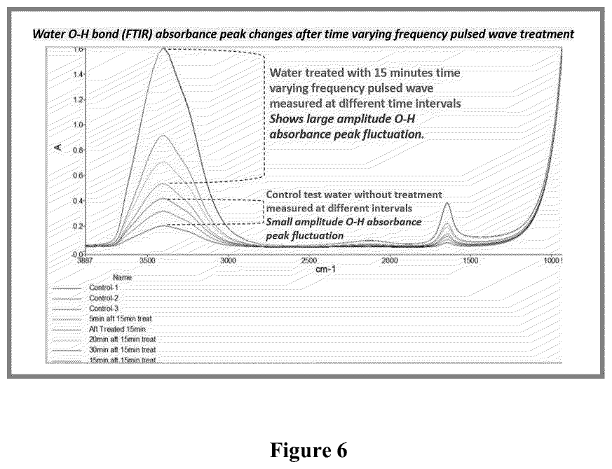

For example, the water O—H bonds in the FTIR absorbance curve in FIG. 6 shows higher peak and great fluctuation at O—H peak indicating the O—H bonds of water or foods/beverage reactivity free energy is increased after correct time varying wave treatment.

Large fluctuation in O—H bonds indicate more vigorous O—H bond vibration see FIG. 6. This will affect the chemoreceptor attachment efficacy of taste chemicals onto the taste bud cells. Hence changes the taste. Due to the taste chemicals in the mouth is also affected by the hydration of water and its reactions with other compounds/food or enzyme in the mouth, the overall changes is therefore varied from food to food. As a general guideline, the electric field of the time varying pulsed wave has the effect in breaking up the hydrogen/polar bond and depending on the strength of the magnetic field and treatment time, the hydrogen bonds may be broken or clustered up. For example, under the time varying wave with high strength magnetic field treatment, the solubility of NaCl salt in water increases and this is reflected in the conductivity and total dissolved solid of NaCl solution.

Salty taste is contributed by Na+ ions when NaCl dissolved in water. When more NaCl dissolved as Na+ in water, the higher will be water electrical conductivity and saltier taste can be picked up. Time varying pulsed wave of this invention has the effect of increasing the NaCl solubility in water hence saltier taste can be picked up for the same amount of salt added.

In addition to increase in NaCl solubility, Na+ ion and its hydration by water molecules is also affected, this results more efficient Na+ saltiness pickup.

This means that even with lesser salt content in the water or foods and beverages, the salty taste is maintained. This will reduce the amount of salt addition and good for high blood pressure control.

Food or beverages containing starch, water or moist when treated with time varying pulsed wave, once it comes in contact with the amylase of saliva, it accelerates the breaking down of the starch into glucose and gives a sweeter taste. For example; starchy food such as potato, bananas, beet root, red carrot, peas taste sweeter after treatment.

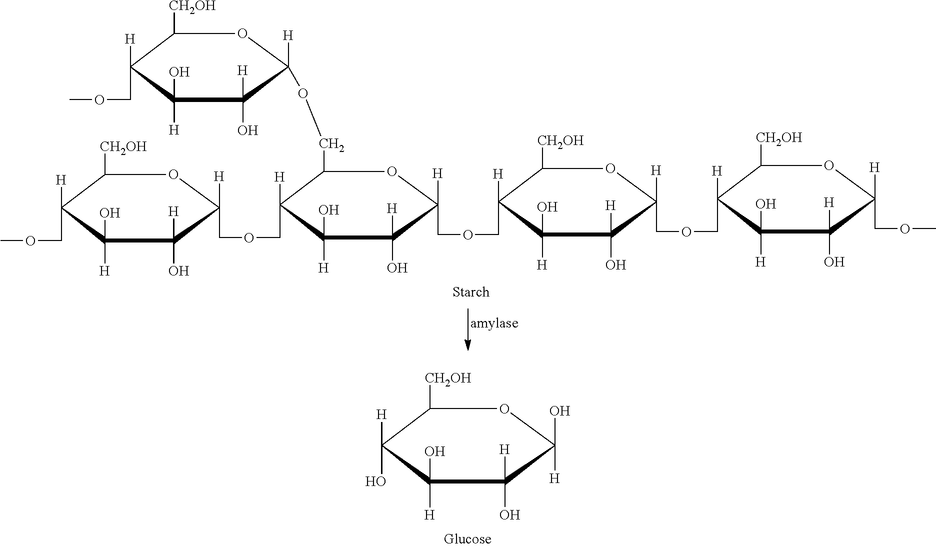

Yet with correct wave electric and magnetic components, bitter taste benzene ring compounds or some long alkane chain group compounds can be broken down reducing the benzene rings compound content. This reduces the bitter taste in foods and beverages such as significant reduction in bitter taste of bitter gourd or beer after treatment.

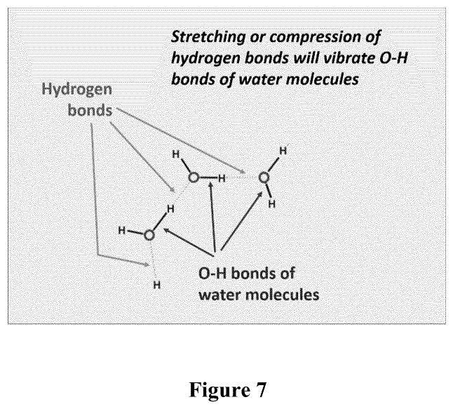

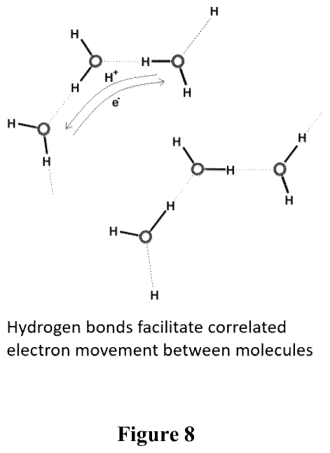

Water when treated with correct time varying electric/magnetic pulsed wave, the water hydrogen bond is stretched or compressed, this result in the correlated electron transport in water and causing the reductive (anti oxidizing) shift in water oxidation reduction potential. This has the effect in reducing the acidity in water. Water without the oxidizing agent content such as residual chlorine such as after boiling when treated with time varying pulsed wave, the water ORP will be shifted to the reducing potential giving the capability of reducing the oxidizing agent/acid in sour taste. Good example is lemon after treatment has very significant reduction in acidic taste. See FIGS. 7 and 8.

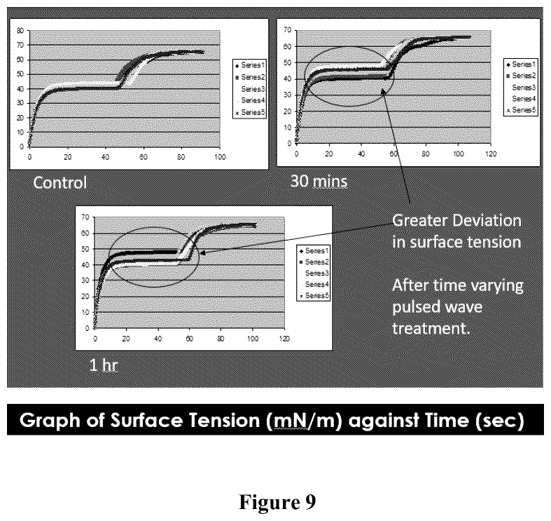

With the correctly chosen time varying treatment, aroma/fragrance of F&B can be further enhanced. Aroma/fragrance is closely relating to the releasing of aroma/fragrance functional group from the water/air interface. Water molecules interaction at water/air interface produces the water surface tension. When water is heated, it reduces the water surface tension and breaking down the water hydrogen bond. It also increases the Brownian motion of the contents and water molecules. The water evaporation rate also increases in this case. This results in easier escape of fragrance functional groups from water and increases the aroma. With the correctly chosen time varying electric/magnetic treatment, it weakens the hydrogen/polar bonds of water and water surface tension fluctuates vigorously. See FIG. 9. This promotes and accelerate the movement of charged molecules at the water air interface hence better releases of fragrance functional groups from foods and beverages.

One good example is better aroma of wine when treated with the correct time varying electric/magnetic field.

Yet another effect is with correct selection of time varying frequency wave and wave components treatment, accelerated polymerization of charged monomers in foods and beverages will also take place. Once these charged monomers polymerized into non charged polymers, its reactivity with saliva protein on tongue will be reduced. For example, tannins and astringent feel in unripe fruits, tea, coffee, wine, whisky and alcoholic drinks after correct time varying frequency wave treatment, the astringent feel is reduced and the “after tastes” of foods and beverages is improved.

The breaking and regrouping of hydrogen bonds in water clusters will result in the compression and stretching of the O—H bond hence the vibration. The same applies to the polar bonds or hydrogen bonds in foods or beverages. Charge carrying ions, molecules, van der Waals forces of foods and beverages and water will also be affected by suitable time varying pulse wave. Such alteration in polar/hydrogen bonds in foods and beverages or water clustering arrangement will affect the hydration and many other physical properties of water including tastes of foods and beverages. The effect can be permanently or for a long lasting period of times.

The conductor probe units 13 used in the present invention for a pulsating time varying frequency electromagnetic wave components for enhancement of taste of foods and beverages 10 shall be inert metal/coating or inert conductive oxide coated. Inert metal refers to gold or platinum. Inert conductive metal oxides can be Iridium oxide, Ruthenium oxide, boron dopped diamond etc. Other conductive materials such as graphite, graphene, iron, silicon-chromium-iron, zinc, copper etc. may be used to produce the effect but if the dissolved ions from these materials affect the food safety, it should not be used. The conductor probe units 13 may be in different geometrical shapes instead of just straight rod, it can be round, circle, plates, mesh etc. and in various sizes to suit different installation site constraints.

In using conductor probe units 13 instead of inductor coil, there is no inductance load, the conductor probe units 13 uses capacitive/resistive load which is mainly an electric field to treat beverages. The present invention for a pulsating time varying frequency electromagnetic wave components for enhancement of taste of foods and beverages 10 was subjected to an alcohol comparative test conducted on wine and whisky. In the comparative test, using inductance load to treat a Red Label Johnny Walker

Whiskey, it will take one to two hours to improve smoothness of said beverage. In using capacitive/resistive electrical fields, the same effect can be achieved within one (1) minute. The same apply to test on red wine Wolf Blass 2017 cabernet sauvignon gold label, it takes forty-five (45) minutes to smoothen the wine and the same smoothness can be achieved when using the conductor probe units 13 with thirty (30) seconds treatment.

To further differentiate the use of coil and probe, using the straight conductor probe, can reduce the oxidation reduction potential (ORP) of water, juices, tea or other beverage. That is, user can convert oxidizing drinks into anti-oxidizing drinks when using the conductor probe units 13. While using a coil cannot change the oxidation reduction potential (ORP) of beverages. Similarly, to change the pH of the media, no prominent effect if using coil, but probe will produce the significant change.

In addition to the above, more than twenty (20) individuals in different sample blind tests has consistently responded to the following results:

For example;
For sweetness enhancement—Select low frequency range PCB+high magnetic/low electric field load path. Tested using cold lemon black tea added with sugar. Treated sample used 50% less sugar addition yet producing the same sweetness if not sweeter taste.
For bitter reduction—Use high frequency range PCB+high electric/low magnetic field load path. Test uses the Chinese bitter gourds with and without treatment. All respondents consistently give significant bitterness reduction although no device can be used to measure the bitterness scale.
For saltiness enhancement—Use medium frequency PCB+high magnetic/low electric field load path. Test uses salt addition to tap water. Approximately 20˜30% reduction in salt addition produces the same saltiness taste.
For sour reduction—Use medium frequency PCB+moderate electric/magnetic field load path. Tests used freshly cut lemon slices for tests. All respondents answered significant sour taste reduction.
For umami enhancement—Use low frequency range PCB+high magnetic/low electric field load path. Chicken stock cooked from treated chicken meat and treated water produced much tastier umami taste as respondent answered.
For astringent reduction—Use low frequency PCB+high magnetic/low electric field load path. Black tea, coffee and wine are all repeatedly in many tests and all treated drinks have significant reduction in astringent mouth feel.
For water energy enhancement—Use medium frequency PCB+moderate electric/magnetic field load path. This is shown in the FTIR curves in the previous discussion.

The preferred embodiment of the present invention for a pulsating time varying frequency electromagnetic wave components for enhancement of taste of foods and beverages 10 is described in the above-mentioned detailed description of the preferred embodiment. While these descriptions directly describe the lone embodiment, it is understood that those skilled in the art may conceive modifications and/or variations to the specific embodiment shown and described therein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art. The foregoing description of a preferred embodiment and best mode of the invention known to the applicant at the time of filing the application has been presented and is intended for the purposes of illustration and description. It is not intended to be exhausted or to limit the present invention to the precise form disclosed, and many modifications and variations are possible in the light of the above teachings.

The embodiment was chosen and described in order to best explain the principles of the present invention and its practical application and to enable others skilled in the applicable art to best utilize the invention in various embodiments and with various modifications as are suited to the particular use contemplated.

1. A pulsating time varying frequency electromagnetic wave components for enhancement of taste of foods and beverages comprising a power supply unit, a printed circuit board connected to said power supply unit and conductor probe units connected to said printed circuit board characterized in that said conductor probe units are taken from a group consisting of straight rods, plates, meshes and coils.

2.-10. (canceled)

11. A method of enhancing taste of foods and beverages using pulsating time varying frequency electromagnetic wave components comprising the steps of:
supplying power to a printed circuit board connected to a power supply unit;
connecting conductor probe units to the printed circuit board, and
subjecting foods and beverages to the conductor probe units wherein said conductor probe units are taken from a group consisting of straight rods, plates, meshes and coils.

12. The method of enhancing taste of foods and beverages using pulsating time varying frequency electromagnetic wave components according to claim 11, wherein said power supply unit is taken from a group consisting of pulsed switching power supply, wet battery, dry battery and transformer rectifier.

13. The method of enhancing taste of foods and beverages using pulsating time varying frequency electromagnetic wave components according to claim 11, wherein said printed circuit board is adapted to produce low frequency range time varying wave.

14. The method of enhancing taste of foods and beverages using pulsating time varying frequency electromagnetic wave components according to claim 11, wherein said printed circuit board as adapted to produce medium frequency range time varying wave.

15. The method of enhancing taste of foods and beverages using pulsating time varying frequency electromagnetic wave components according to claim 11, wherein said printed circuit board is adapted to produce high frequency range time varying wave.

16. The method of enhancing taste of foods and beverages using pulsating time varying frequency electromagnetic wave components according to claim 11, wherein said conductor probe units are adapted to create in its vicinity time varying electromagnetic field.

17. The method of enhancing taste of foods and beverages using pulsating time varying frequency electromagnetic wave components according to claim 11, wherein said conductor probe units are adapted to produce high electric field and low magnetic field.

18. The method of enhancing taste of foods and beverages using pulsating time varying frequency electromagnetic wave components according to claim 11, wherein said conductor probe units are adapted to produce pulsed ionic/electron wave in an electrolyte.

19. The method of enhancing taste of foods and beverages using pulsating time varying frequency electromagnetic wave components according to claim 11, wherein said power supply unit is adapted to provide direct current power to the printed circuit board.

20. The method of enhancing taste of foods and beverages using pulsating time varying frequency electromagnetic wave components according to claim 19 wherein said printed circuit board is adapted to convert the direct current power into various frequency ranges of time varying wave.

21. An apparatus system for use in enhancing taste of foods and beverages using pulsating time varying frequency electromagnetic wave components according to claim 11 comprising
a power supply unit;
a printed circuit board connected to said power supply unit; and
conductor probe units connected to said printed circuit board characterized in that said conductor probe units are taken from a group consisting of straight rods, plates, meshes and coils;
wherein,
the power supply unit is selected from a group consisting of pulsed switching power supply, wet battery, dry battery and transformer rectifier;
the printed circuit board is adapted to produce low, medium and high frequency range time varying waves using a control device; and
the conductor probe units are adapted to create in its vicinity time varying electromagnetic field and to produce pulsed ionic/electron wave in an electrolyte.

22. The apparatus system for use in enhancing taste of foods and beverages according to claim 21, wherein the power supply unit is adapted to provide direct current power to the printed circuit board and the printed circuit board is adapted to convert the direct current power into various frequency ranges of time varying wave.
